(19) United States
(12) Patent Application Publication
(10) Pub. No.: US 2023/0208199 A1
(43) Pub. Date: Jun. 29, 2023

(54) CONTACTLESS POWER SUPPLY SYSTEM

(71) Applicant: TOYODA GOSEI CO., LTD., Kiyosu-shi (JP)

(72) Inventors: Teppei ABE, Kiyosu-shi (JP); Shinichiro FUKI, Kiyosu-shi (JP); Tomokazu SAKAI, Kiyosu-shi (JP); Shigeo TAKEDA, Kiyosu-shi (JP); Yuki TOKUYAMA, Kiyosu-shi (JP)

(21) Appl. No.: 18/063,130

(22) Filed: Dec. 8, 2022

(30) Foreign Application Priority Data
Dec. 23, 2021 (JP) 2021-209837

(51) Int. Cl. H02J 50/20; H02J 50/80; H02J 50/90

(52) U.S. Cl. CPC H02J 50/20; H02J 50/80; H02J 50/90

(57) ABSTRACT

A contactless power supply system includes power receiving devices, a power transmitting device, and a determining unit. The power receiving devices each include a transmitting unit and a power receiving unit. The power transmitting device includes a receiving unit and a power supplying unit. Efficiency condition information is defined that includes an efficiency condition that indicates that the power transmitting device can transmit power to a power receiving device efficiently. The determining unit is configured to determine, based on the efficiency condition information, the power receiving device that satisfies the efficiency condition as the power receiving device to which the power transmitting device transmits power, among the power receiving devices from which the receiving unit has received the beacon signals. The power supplying unit is configured to supply power to the power receiving device that has been determined by the determining unit.

### BACKGROUND

### 1. Field

The present disclosure relates to a contactless power supply system.

### 2. Description of Related Art

Techniques related to contactless power supply using a power transfer signal are typical.

In a typical technique, a power receiving device transmits a beacon signal to a power transmitting device from which the power receiving device requests power supply. The power transmitting device supplies power to the power receiving device based on the received beacon signal. In a case in which multiple power receiving devices transmit beacon signals to the power transmitting device and the power transmitting device supplies power to the power receiving devices, power transfer signals for the respective power receiving devices interfere with each other, hindering efficient power supply. In addition, depending on the orientations of the power receiving devices with respect to the power transmitting device and the distance from the power transmitting device to each power receiving device, the power transmitting device may be unable to efficiently supply power to any of the power receiving devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a contactless power supply system is provided that includes power receiving devices, a power transmitting device, and a determining unit. The power receiving devices each includes a transmitting unit and a power receiving unit. The transmitting unit is configured to transmit a beacon signal to the power transmitting device, from which the power receiving unit requests power supply. The power receiving unit is configured to receive power from the power transmitting device by contactless power supply. The power transmitting device includes a receiving unit and a power supplying unit. The receiving unit is configured to receive the beacon signal from the power receiving devices. The power supplying unit is configured to supply power to the power receiving devices by contactless power supply. Efficiency condition information is defined that includes an efficiency condition that indicates that the power transmitting device can transmit power to a power receiving device efficiently. The determining unit is configured to determine, based on the efficiency condition information, the power receiving device that satisfies the efficiency condition as the power receiving device to which the power transmitting device transmits power, among the power receiving devices from which the receiving unit has received the beacon signals. The power supplying unit is configured to supply power to the power receiving device that has been determined by the determining unit.

Other features and aspects will be apparent from the following detailed description, the drawings, and the claims.

### BRIEF DESCRIPTION OF THE DRAWINGS

FIG. 1 is a diagram showing an overall configuration of a contactless power supply system.

FIG. 2 is a diagram showing one example of the configuration of the contactless power supply system.

FIG. 3 is a flowchart showing one example of a determination process.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

A contactless power supply system 1 according to one embodiment will now be described with reference to the drawings.

[Overall Configuration of Contactless Power Supply System 1]

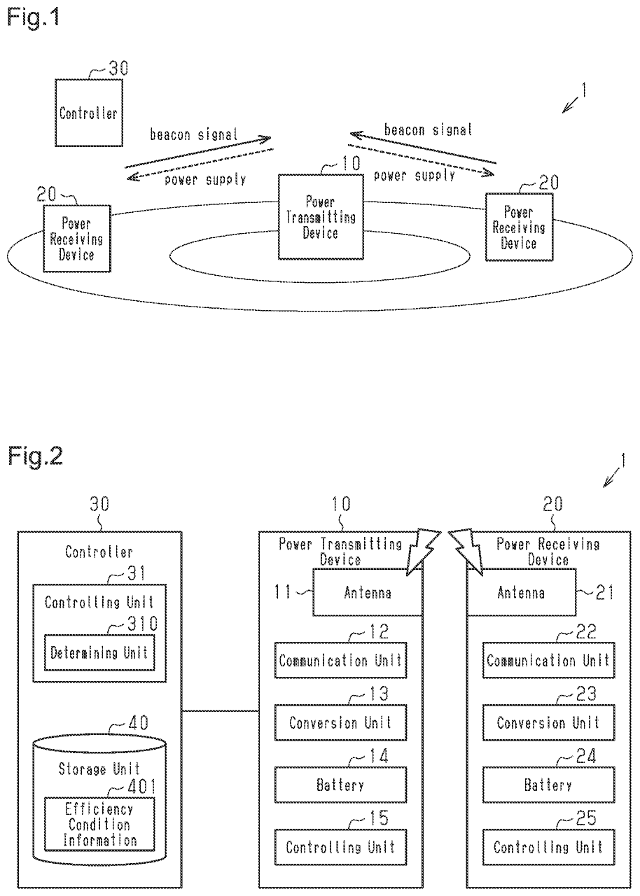

As shown in FIG. 1, the contactless power supply system 1 includes a power transmitting device 10, power receiving devices 20, and a controller 30. For example, the power transmitting device 10 supplies power to the power receiving devices 20 through contactless power supply using power transfer signals. Specifically, the contactless power supply system 1 wirelessly transfers power using a microwave method for contactless power supply. That is, the power transmitting device 10 and the power receiving devices 20 transmit and receive power transfer signals for contactless power supply between power receiving antennas of the power receiving devices 20 and the power transmitting antenna of the power transmitting device 10. The wireless power transfer method (contactless power transfer method) employed in this system is not limited to the microwave method, but may be an electromagnetic induction method, a magnetic field resonance method, an electric field resonance method, or a method using a laser. In the present embodiment, the transmission and reception of the power transfer signals are used for the contactless power supply. However, the wireless transmission and reception of the power transfer signals may be performed for purposes other than the contactless power supply.

Each power receiving device 20 receives a power transfer signal transmitted from the power transmitting device 10, and operates with the received power or charges its own battery with the received power. The controller 30 controls power supply to the power receiving devices 20 by the power transmitting device 10.

In order to properly transmit a power transfer signal to each power receiving device 20, the power transmitting device 10 is required to properly set the phase of the power transfer signal based on the orientation of the power receiving device 20 with respect to the power transmitting device 10 and the distance to the power receiving device 20. Accordingly, the power receiving device 20 transmits a beacon signal including phase change information to the power transmitting device 10, from which the power receiving device 20 requests power supply, at specified time intervals. The power transmitting device 10 supplies power to the power receiving device 20 based on the phase change information included in the beacon signal from the power receiving device 20.

In a case in which two or more of the power receiving devices 20 transmit beacon signals to the power transmitting device 10 and the power transmitting device 10 supplies power to those power receiving devices 20, the power transfer signals for the respective power receiving devices 20 interfere with each other. This may hinder efficient power supply. In addition, depending on the orientations of the power receiving devices 20 with respect to the power transmitting device 10 and the distance from the power transmitting device 10 to each power receiving device 20, the power transmitting device 10 may be unable to efficiently supply power to any of the power receiving devices 20.

When the power transmitting device 10 receives beacon signals from the power receiving devices 20, the controller 30 according to the present embodiment determines a power receiving device 20 to which the power transmitting device 10 can supply power efficiently. The configuration of the power transmitting device 10, the configuration of the power receiving device 20, and the configuration of the controller 30 will now be described.

[Configuration of Power Transmitting Device 10]

As shown in FIG. 2, the power transmitting device 10 includes, for example, an antenna 11, a communication unit 12, a conversion unit 13, a battery 14, and a controlling unit 15.

The antenna 11 is used for various types of communication with the power receiving devices 20. The antenna 11 is commonly used, for example, in communication related to power transfer signals, communication related to beacon signals, and information communication related to transmission and reception of various types of information. The antenna 11 is an example of a power supplying unit. The antenna 11 transmitting power transfer signals to the power receiving devices 20 is an example of supplying power to the power receiving devices 20 by contactless power supply.

The communication unit 12 performs various types of control related to communication with the power receiving devices 20. The communication unit 12 controls, for example, the antenna 11 and receives beacon signals transmitted by the power receiving devices 20. The communication unit 12 controls the antenna 11 to transmit and receive various kinds of information to and from the power receiving devices 20. The communication unit 12 may be circuitry including: 1) one or more processors that operate according to a computer program (software); 2) one or more dedicated hardware circuits (application specific integrated circuits: ASIC) that execute at least part of various processes; or 3) a combination thereof. The information communication related to transmission and reception of various types of information is implemented by, for example, Bluetooth (registered trademark), Wi-Fi, or ZigBee (registered trademark). The communication unit 12 is an example of a receiving unit in a process of controlling the antenna 11 and receiving beacon signals from the power receiving devices 20.

When supplying power to a power receiving device 20, the conversion unit 13 converts power into a power transfer signal and transmits the power transfer signal via the antenna 11. The conversion unit 13 may convert power supplied from a power source (not shown) into a power transfer signal, or may convert power stored in the battery 14 (described below) into a power transfer signal. In the following description, a case in which the conversion unit 13 converts power stored in the battery 14 into power transfer signals will be described.

The battery 14 stores power supplied from the power source (not shown). The power capacity of the battery 14 when fully charged is, for example, a power capacity capable of supplying sufficient power to the power receiving devices 20 in the contactless power supply system 1.

The controlling unit 15 controls each unit included in the power transmitting device 10. The controlling unit 15 may include circuitry including a hardware processor such as a central processing unit (CPU) configured to execute computer programs (software). Some or all of the constituent elements of the circuitry may be implemented by hardware such as a large scale integration (LSI), an application specific integrated circuit (ASIC), a field-programmable gate array (FPGA), or a graphics processing unit (GPU), or may be implemented by cooperation of software and hardware. The programs may be stored in advance in a storage device (not shown) including a non-transitory storage medium such as a hard disk drive (HDD) or a flash memory included in the power transmitting device 10. For example, the controlling unit 15 adjusts the phase of the antenna 11 based on beacon signals received by the communication unit 12.

[Configuration of Power Receiving Device 20]

The power receiving device 20 includes an antenna 21, a communication unit 22, a conversion unit 23, a battery 24, and a controlling unit 25.

The antenna 21 is used for various types of communication with the power transmitting device 10. The antenna 21 is commonly used, for example, in communication related to power transfer signals, communication related to beacon signals, and information communication related to transmission and reception of various types of information. The antenna 21 is an example of a power receiving unit. The antenna 21 receiving a power transfer signal transmitted by the power transmitting device 10 is an example of receiving power from the power transmitting device 10 by contactless power supply.

The communication unit 22 performs various types of control related to communication with the power transmitting device 10. The communication unit 22 controls, for example, the antenna 21 to transmit a beacon signal to the power transmitting device 10, from which the power receiving device 20 requests power supply. The communication unit 22 controls the antenna 21 to transmit and receive various kinds of information to and from the power transmitting device 10. The communication unit 22 may be circuitry including: 1) one or more processors that operate according to a computer program (software); 2) one or more dedicated hardware circuits (application specific integrated circuits: ASIC) that execute at least part of various processes; or 3) a combination thereof. The communication unit 22 is an example of a transmitting unit in a process of controlling the antenna 21 and transmitting a beacon signal to the power transmitting device 10.

The conversion unit 23 converts the power transfer signal received by the antenna 21 into direct-current power. The battery 24 stores the direct-current power converted by the conversion unit 23. The power receiving device 20 operates by the power stored in the battery 24.

The controlling unit 25 controls each unit included in the power receiving device 20. The controlling unit 25 may include circuitry including a hardware processor such as a CPU configured to execute computer programs (software). Some or all of the constituent elements of the circuitry may be implemented by hardware such as an LSI, an ASIC, an FPGA, or a GPU, or may be implemented by cooperation of software and hardware. The programs may be stored in advance in a non-transitory storage medium such as an HDD or a flash memory included in the power receiving device 20. The controlling unit 25 instructs the communication unit 22 to transmit beacon signals to the power transmitting device 10, for example, at predetermined time intervals.

[Configuration of Controller 30]

The controller 30 of the present embodiment is connected to the power transmitting device 10 so as to transmit and receive information. The controller 30 and the power transmitting device 10 may be directly connected to each other. Alternatively, a communication unit (not shown) may be used to perform information communication related to transmission and reception of various types of information.

The controller 30 includes a controlling unit 31 and a storage unit 40. The controlling unit 31 may include circuitry including a hardware processor such as a CPU configured to execute computer programs (software). Some or all of the constituent elements of the circuitry may be implemented by hardware such as an LSI, an ASIC, an FPGA, or a GPU, or may be implemented by cooperation of software and hardware. The programs may be stored in advance in the storage unit 40, which includes a non-transitory storage medium such as an HDD or a flash memory included in advance in the controller 30.

The storage unit 40 may be implemented by the various storage devices described above. Alternatively, the storage unit 40 may be implemented by an electrically erasable programmable read-only memory (EEPROM), a read-only memory (ROM), a random-access memory (RAM), or the like. In addition to the above-described programs, the storage unit 40 stores efficiency condition information 401. The efficiency condition information 401 is information indicating an efficiency condition used by the controller 30 in a process of determining the power receiving device 20 to which power can be supplied efficiently.

In this example, a case will be described in which the efficiency condition information 401 includes information indicating three efficiency conditions: a first efficiency condition EC1, a second efficiency condition EC2, and a third efficiency condition EC3. The first efficiency condition EC1 is, for example, that the loss of the power transmitted from the power transmitting device 10 to the power receiving device 20 is relatively small in a period before the power is received by the power receiving device 20. The second efficiency condition EC2 is, for example, that the reception strength of a beacon signal is relatively high. The third efficiency condition EC3 is, for example, that the angle of arrival of a beacon signal agrees with the directivity of the antenna 11.

The controlling unit 31 includes, for example, a determining unit 310. The determining unit 310 may include circuitry including a hardware processor such as a CPU configured to execute computer programs (software). Based on the efficiency condition indicated by the efficiency condition information 401, the determining unit 310 determines, among the power receiving devices 20 from which beacon signals have been received, the power receiving device 20 that satisfies the efficiency condition as the power receiving device 20 to which the power transmitting device 10 supplies power. The determining unit 310 instructs the power transmitting device 10 to supply power to the determined power receiving device 20. Based on an instruction from the controller 30, the power transmitting device 10 supplies power to the power receiving device 20 determined by the determining unit 310, among the multiple power receiving devices 20 from which beacon signals have been received.

[Operation Flow]

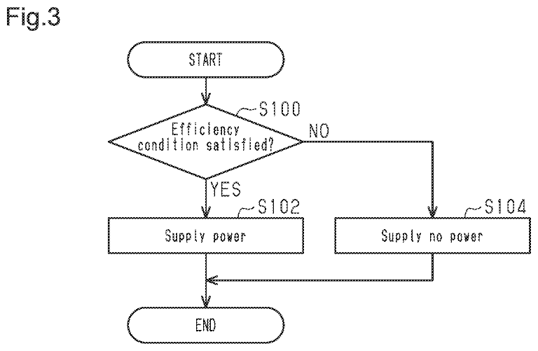

The process performed by the determining unit 310 will now be described with reference to FIG. 3. The process of the flowchart shown in FIG. 3 is executed when the power transmitting device 10 receives beacon signals from the power receiving devices 20. First, the determining unit 310 determines whether each of the power receiving devices 20 from which the power transmitting device 10 has received the beacon signals satisfies the efficiency condition based on the efficiency condition indicated by the efficiency condition information 401 (step S100).

When determining the power receiving device 20 based on the first efficiency condition EC1, the determining unit 310 acquires, from the power transmitting device 10, information indicating received power, which is received by the power receiving device 20, and information indicating supplied power, which is supplied to the power receiving device 20 by the power transmitting device 10. In this case, the power transmitting device 10 transmits a power transfer signal to each of the power receiving devices 20 from which the beacon signals have been received, thereby supplying power to the power receiving devices 20. The antenna 21 of each power receiving device 20 receives the power transfer signal transmitted by the power transmitting device 10. The conversion unit 23 converts the power transfer signal received by the antenna 21 into direct-current power. The communication unit 22 of the power receiving device 20 transmits the magnitude of the direct-current power converted by the conversion unit 23 to the power transmitting device 10 as information indicating the received power. The communication unit 12 of the power transmitting device 10 outputs, to the controller 30, the information indicating the received power (the information is transmitted by the power receiving device 20) and the information indicating the supplied power (the supplied power refers to the power supplied to the power receiving device 20 by the power transmitting device 10).

The determining unit 310 compares the information indicating the received power acquired from each power receiving device 20 with the information indicating the supplied power supplied to the power receiving device 20 by the power transmitting device 10, and determines the power receiving device 20 in which the loss of the received power is smaller than those of the other power receiving devices 20 as the power receiving device 20 that satisfies the efficiency condition.

When determining the power receiving device 20 based on the second efficiency condition EC2, the determining unit 310 acquires, from the power transmitting device 10, information indicating the reception strengths of the beacon signals received by the power transmitting device 10. The determining unit 310 compares the information indicating the reception strengths of the beacon signals received by the power transmitting device 10, and determines, as the power receiving device 20 that satisfies the efficiency condition, the power receiving device 20 of which the reception strength is higher than the other power receiving devices 20.

When determining the power receiving device 20 based on the third efficiency condition EC3, the determining unit 310 acquires, from the power transmitting device 10, information indicating the angles of arrival of the beacon signals received by the power transmitting device 10 and information indicating the directivity of the antenna 11. The determining unit 310 compares the information indicating the angles of arrival of the beacon signals received by the power transmitting device 10 with the directivity of the antenna 11, and determines, as the power receiving device 20 that satisfies the efficiency condition, the power receiving device 20 of which the angle of arrival of the beacon signal agrees with the directivity to a greater extent than the other power receiving devices 20.

The determining unit 310 of the present embodiment determines, as the power receiving device 20 that satisfies the efficiency condition, the power receiving device 20 that satisfies any one of the first efficiency condition EC1, the second efficiency condition EC2, and the third efficiency condition EC3.

The determining unit 310 determines that the power transmitting device 10 supplies power to the power receiving device 20 determined to satisfy the efficiency condition, among the multiple power receiving devices 20 that have transmitted the beacon signal to the power transmitting device 10 (step S102). The determining unit 310 determines that the power transmitting device 10 does not supply power to the power receiving devices 20 determined to not satisfy the efficiency condition among the multiple power receiving devices 20 that have transmitted the beacon signals to the power transmitting device 10 (step S104). Based on the determination result of the determining unit 310, the power transmitting device 10 transmits a power transfer signal to the power receiving device 20 that has been determined to be subject of power supply, and does not transmit a power transfer signal to any of the power receiving devices 20 that have not been determined to be subject of power supply.

[Operational Advantages of Embodiment]

The above-described embodiment has the following operational advantages.

(1) Based on the efficiency condition, the determining unit 310 determines, as the power receiving device 20 to which the power transmitting device 10 supplies power, the power receiving device 20 that satisfies the efficiency condition, among the multiple power receiving devices 20 from which the beacon signals have been received by the power transmitting device 10.

This configuration allows the power transmitting device 10 to supply power to one of the power receiving devices 20 based on the determination by the determining unit 310. By supplying power to one of the power receiving devices 20, the power transmitting device 10 suppresses the occurrence of interference among power transfer signals and efficiently supplies power to the power receiving device 20 as compared with a case in which power is supplied to all of the power receiving devices 20.

(2) The power efficiency condition includes the first power efficiency condition EC1, which indicates that the loss of the power transmitted from the power transmitting device 10 to the power receiving device 20 is relatively small in the period before the power is received by the power receiving device 20. The determining unit 310 compares the supplied power, which is supplied from the power transmitting device 10 to the power receiving device 20, with the received power, which is received by the power receiving device 20 from the power transmitting device 10. The determining unit 310 determines the power receiving device 20 that has a smaller loss than the other power receiving devices 20 as the power receiving device 20 to which the power transmitting device 10 supplies power. This configuration allows the power transmitting device 10 to efficiently supply power to the power receiving device 20 with a relatively small loss, based on the determination by the determining unit 310.

(3) The efficiency condition includes the second efficiency condition EC2, which indicates that the reception strength of the beacon signal is relatively high. The determining unit 310 determines, as the power receiving device 20 to which power is supplied from the power transmitting device 10, the power receiving device 20 that has transmitted a beacon signal having a higher reception strength than the other beacon signals received by the power transmitting device 10. The power receiving device 20 that transmits a beacon signal having a high reception strength may be located at a position closer to the power transmitting device 10 than the other power receiving devices 20. A power receiving device 20 closer to the power transmitting device 10 may have a higher power supply efficiency than the power receiving devices 20 farther from the power transmitting device 10. The above-described configuration allows the determining unit 310 to determine, among the multiple power receiving devices 20, the power receiving device 20 that is located close to the power transmitting device 10 and to which the power transmitting device 10 can supply power efficiently. Therefore, the power transmitting device 10 supplies power to the power receiving device 20 efficiently.

(4) The efficiency condition includes the third efficiency condition EC3, which indicates that the angle of arrival of the beacon signal agrees with the directivity of the antenna 11. The determining unit 310 determines, as the power receiving device 20 to which the power transmitting device 10 supplies power, the power receiving device 20 that has transmitted a beacon signal having an angle of arrival that agrees with the directivity of the antenna 11 to a greater extent than the other beacon signals received by the power transmitting device 10. The power receiving device 20 that transmits the beacon signal of which the angle of arrival agrees with the directivity of the antenna 11 of the power transmitting device 10 may be able to receive the power transfer signal from the power transmitting device 10 more efficiently than the other power receiving devices 20. The above-described configuration thus allows the determining unit 310 to determine, among the multiple power receiving devices 20, the power receiving device 20 to which the power transmitting device 10 can supply power efficiently since the direction of the power supply by the power transmitting device 10 agrees with the position where the power receiving device 20 is present. Therefore, the power transmitting device 10 supplies power to the power receiving device 20 efficiently.

The above-described embodiment may be modified as follows. The above-described embodiment and the following modifications can be combined as long as the combined modifications remain technically consistent with each other.

In the example illustrated in FIG. 1, the number of the power receiving devices 20 included in the contactless power supply system 1 is two. However, the number of the power receiving devices 20 is not limited thereto. The contactless power supply system 1 may include one power receiving device 20 or more than two power receiving devices 20. An upper limit may be set for the number of the power receiving devices 20 included in the contactless power supply system 1. The upper limit of the number of the power receiving devices 20 may be determined in accordance with, for example, power that can be supplied by the power transmitting device 10 in the contactless power supply system 1.

In the above-described embodiment, a case has been described in which the power transmitting device 10 operates with power supplied from a power source (not shown). However, the present disclosure is not limited thereto. Two or more contactless power supply systems 1 may cooperate with each other, and each power transmitting device 10 may operate by being supplied with the power of a power transfer signal transmitted from the power transmitting device 10 included in another contactless power supply system 1.

In the above-described embodiment, a case has been described in which the efficiency condition information 401 includes information indicating three efficiency conditions: the first efficiency condition EC1, the second efficiency-condition EC2, and the third efficiency condition EC3. However, the present disclosure is not limited thereto. The number of efficiency conditions included in the efficiency condition information 401 may be one, two, or greater than three.

When there are multiple efficiency conditions, an order of priority may be set for the efficiency conditions. For example, the priority of the first efficiency condition EC1 may be set higher than those of the second efficiency condition EC2 and the third efficiency condition EC3. In this case, the determining unit 310 determines, as the power receiving device 20 that satisfies the efficiency condition, the power receiving device 20 that has been determined to satisfy the first efficiency condition EC1 regardless of whether that power receiving device 20 satisfies the second efficiency condition EC2 and the third efficiency condition EC3.

When there are two or more power receiving devices 20 that satisfy any one of the efficiency conditions, the determining unit 310 may determine, as the power receiving device 20 satisfying the efficiency condition, the power receiving device 20 that satisfies the efficiency condition to which a higher priority has been given, among the power receiving devices 20.

In the above-described embodiment, the determining unit 310 determines, as the power receiving device 20 that satisfies the efficiency condition, the power receiving device 20 that satisfies any one of the first efficiency condition EC1, the second efficiency condition EC2, and the third efficiency condition EC3. However, the present disclosure is not limited thereto. The determining unit 310 may determine, as the power receiving device 20 that satisfies the efficiency condition, the power receiving device 20 that satisfies all of the first efficiency condition EC1, the second efficiency condition EC2, and the third efficiency condition EC3.

In the above-described embodiment, a case has been described in which the power transmitting device 10 and the controller 30 are provided separately. However, the present disclosure is not limited thereto. The power transmitting device 10 may have, for example, the function of the controller 30. In this case, the efficiency condition information 401 is stored in the storage device of the power transmitting device 10, and the controlling unit 15 of the power transmitting device 10 includes the determining unit 310. When the contactless power supply system 1 includes two or more power transmitting devices 10, the power transmitting devices 10 may transmit and receive, to and from each other, information indicating the power receiving device 20 that satisfies the efficiency condition determined by information communication, and may determine, in an integrated manner, the power receiving device 20 to which each of the power transmitting devices 10 supplies power. Specifically, when some or all of the power transmitting devices 10 have determined to supply power to the same power receiving device 20, the power transmitting device 10 having a higher priority supplies power to the power receiving device 20 that has been determined to be the one to be supplied with power, based on the priority assigned to each power transmitting device 10.

In the above-described embodiment, the antenna 11 and the antenna 21 are used in the communication related to power transfer signals, the communication related to beacon signals, and the information communication related to transmission and reception of various types of information. However, the present disclosure is not limited thereto. The power transmitting device 10 and the power receiving devices 20 may each include separate antennas respectively used for the communication related to power transfer signals, the communication related to beacon signals, and the information communication related to transmission and reception of various types of information. For example, when the information communication related to transmission and reception of various kinds of information is frequently performed between the power transmitting device 10 and the power receiving devices 20, the antenna 11 and the antennas 21 may fail to be properly used for the transmission and reception of power transfer signals or the transmission and reception of beacon signals. If the power transmitting device 10 and the power receiving devices 20 each include separate antennas used for the communication related to power transfer signals, the communication related to beacon signals, and the information communication related to transmission and reception of various types of information, each type of communication is prevented from being interfered with another type of communication.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A contactless power supply system, comprising power receiving devices, a power transmitting device, and a determining unit, wherein
the power receiving devices each includes:
a transmitting unit that is configured to transmit a beacon signal to the power transmitting device, from which the power receiving unit requests power supply; and
a power receiving unit that is configured to receive power from the power transmitting device by contactless power supply,
the power transmitting device includes:
a receiving unit that is configured to receive the beacon signal from the power receiving devices; and
a power supplying unit that is configured to supply power to the power receiving devices by contactless power supply,
efficiency condition information is defined that includes an efficiency condition that indicates that the power transmitting device can transmit power to a power receiving device efficiently,
the determining unit is configured to determine, based on the efficiency condition information, the power receiving device that satisfies the efficiency condition as the power receiving device to which the power transmitting device transmits power, among the power receiving devices from which the receiving unit has received the beacon signals, and
the power supplying unit is configured to supply power to the power receiving device that has been determined by the determining unit.

2. The contactless power supply system according to claim 1, wherein
the efficiency condition includes a condition that a loss of power supplied from the power transmitting device to a power receiving device is relatively small in a period before the power is received by the power receiving device,
power supplied to the power receiving devices by the power transmitting device is defined as supplied power, power received by the power receiving device from the power transmitting device is defined as received power, and the determining unit is configured to determine, based on the supplied power and the received power, the power receiving device of which the loss is smaller than the other power receiving devices as the power receiving device to which the power transmitting device supplies power.

3. The contactless power supply system according to claim 1, wherein
the efficiency condition includes a condition that a reception strength of the beacon signal is relatively high, and
the determining unit is configured to determine, as the power receiving device to which the power transmitting device supplies power, the power receiving device that has transmitted the beacon signal having a higher reception strength than the other beacon signals received by the receiving unit.

4. The contactless power supply system according to claim 1, wherein
the efficiency condition includes a condition that an angle of arrival of the beacon signal agrees with a directivity of the receiving unit, and
the determining unit is configured to determine, as the power receiving device to which the power transmitting device supplies power, the power receiving device that has transmitted the beacon signal having an angle of arrival that agrees with the directivity to a greater extent than the other beacon signals received by the receiving unit.

5. The contactless power supply system according to claim 1, further comprising a controller that includes the determining unit.

6. The contactless power supply system according to claim 1, wherein the power transmitting device includes the determining unit.
